(19) United States
(12) Patent Application Publication
(10) Pub. No.: US 2013/0130785 A1
(43) Pub. Date: May 23, 2013

(54) METHOD AND APPARATUS FOR CONSUMER REWARDS

(71) Applicant: Maynard SMALL, Kansas City, MO (US)

(72) Inventor: Maynard SMALL, Kansas City, MO (US)

(73) Assignee: Maynard SMALL, Kansas City, MO (US)

(21) Appl. No.: 13/679,215

(22) Filed: Nov. 16, 2012

Related U.S. Application Data
(60) Provisional application No. 61/561,690, filed on Nov. 18, 2011.

(51) Int. Cl. A63F 13/00

(52) U.S. Cl. CPC A63F 13/00
USPC 463/25; 463/44; 463/30

(57) ABSTRACT

A matching game and method implemented on a mobile computing device, the method including displaying a virtual game card on a display of the computing device. The virtual game card may have a plurality of indicia displayed in a grid format. Next, the method may include receiving information scanned by the computing device and either positively or negatively marking one of the indicia depending on the information scanned by the computing device. The method may then include continuing to receive information scanned by the computing device and positively or negatively marking corresponding ones of the indicia until each of the indicia on the virtual game card is positively or negatively marked or until at least one winning combination of indicia is positively marked. If at least one winning combination is positively marked, the method may include displaying an indication that a user of the computing device won.

### RELATED APPLICATIONS

This application claims priority benefit of a provisional application entitled, “Method and Apparatus for Consumer Rewards,” Ser. No. 61/561,690, filed Nov. 18, 2011 and incorporated by reference herein in its entirety.

### BACKGROUND

Various smartphones and other mobile devices are capable of scanning barcodes on products to create a shopping list, compare prices at different stores, or participate in games to win prizes. For example, some smartphone apps provide a list of specific products or brands to be scanned and award a pre-determined amount of points or “coins” for scanning barcodes of those specific products or brands in a store. This scanning of items is used as a means to accumulate points or coins only, not as a part of a game itself. Then those points or coins can be accumulated and used to earn the right to play a game of chance similar to slots or other such games. If the game of chance is won, the smartphone user or player of the game may be awarded a prize. However, the multi-step process of scanning bar codes to earn the right to play a game for a chance at winning a prize can be seen as tedious to some users. Furthermore, such smartphone apps generally provide a set number of coins or points for specific product barcodes, giving the user no incentive to try scanning other non-listed products of a particular brand.

### SUMMARY

Embodiments of the present invention solve the above-mentioned problems and provide a distinct advance in the art of providing consumer incentives via a game played on a mobile computing device. An embodiment of the invention is a method of facilitating a matching game. The method may include displaying a virtual game card on a display of a computing device. The virtual game card may have a plurality of indicia displayed in a grid format. Next, the method may include receiving information scanned by the computing device and either positively or negatively marking at least one of the plurality of indicia depending on the information scanned by the computing device. For example, at least one of the indicia may be positively marked by changing at least one visual element thereof in a first manner if it corresponds to the information scanned by the computing device. Furthermore, at least one of the indicia may be negatively marked by changing a visual element thereof in a second manner if it does not correspond to the information scanned by the computing device.

The method may then include continuing to receive information scanned by the computing device and positively or negatively marking corresponding ones of the indicia until each of the indicia on the virtual game card is positively or negatively marked or until at least one winning combination of indicia is positively marked. If at least one winning combination of indicia is positively marked, the method may then include displaying an indication that at least one winning combination of indicia is positively marked on the virtual game card, thereby indicating that a user of the computing device won the matching game.

Another embodiment of the invention may be a non-transitory computer-readable medium with a computer program stored thereon for facilitating playing a matching game, such as bingo, via a computing device. The computer program may include code segments executable by the computing device for performing the method steps described above, such as receiving scanned information (e.g., information from scanned bar codes or QR codes) and positively or negatively marking spaces or indicia on a virtual game card based on the scanned information. In addition to having a code segment for displaying an indication that at least one winning combination of indicia is positively marked on the virtual game card, the computer program may have a code segment for displaying an award image or code and/or crediting an award to an account associated with a user of the computing device for winning the matching game.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram of a computing device constructed in accordance with an embodiment of the present invention and configured for playing a matching game thereon;

FIG. 2 is a schematic view of the computing device with a menu screen displayed thereon and illustrates selection of a logo corresponding with the matching game;

FIG. 3 is a schematic view of the computing device with a home screen of the matching game displayed thereon, including a plurality of selectable options;

FIG. 4 is a schematic view of the computing device with a registration form displayed thereon, configured to be with information from a user of the computing device to register for the matching game;

FIG. 5 is a schematic view of the computing device with a virtual game card displayed thereon for playing the matching game, further illustrating a positively marked free space and the user's selection of a first selectable space on the virtual game card;

FIG. 6 is a schematic view of the computing device with a scan window displayed thereon and indicia corresponding with the first selectable space;

FIG. 7 is a schematic view of the computing device with the scan window of FIG. 6 displayed thereon and a barcode aligned within the scan window while being scanned or photographed by the computing device;

FIG. 8 is a schematic view of the computing device with a product image and additional information corresponding to the barcode of FIG. 7 being displayed thereon;

FIG. 9 is a schematic view of the computing device with the virtual game card displayed thereon, illustrating both the free space and the first selectable space positively marked and the user's selection of a second selectable space on the virtual game card;

FIG. 10 is a schematic view of the computing device with a scan window displayed thereon and indicia corresponding with the second selectable space;

FIG. 11 is a schematic view of the computing device with the scan window of FIG. 10 displayed thereon and a barcode aligned within the scan window while being scanned or photographed by the computing device;

FIG. 12 is a schematic view of the computing device with a product image and additional information corresponding to the barcode of FIG. 11 being displayed thereon;

FIG. 13 is a schematic view of the computing device with the virtual game card displayed thereon, illustrating the free space, the first selectable space, and the second selectable space being positively marked and arranged in a diagonal configuration, thereby forming a winning combination of positively marked spaces;

FIG. 14 is a schematic view of the computing device with the virtual game card displayed thereon, illustrating the free space and the first selectable space being positively marked, but the second selectable space being negatively marked, such that the diagonally-aligned spaces of the first selectable space, the free space, and the second selectable space do not form a winning combination of positively marked spaces;

FIG. 15 is a schematic view of the computing device with a screen displaying a plurality of prizes awarded to an account of the user of the computing device by achieving different winning combinations of spaces on the virtual game card;

FIG. 16 is a schematic view of the computing device with a screen displaying a coupon prize awarded to the user of the computing device and including a scannable bar code for redeeming the coupon prize; and

FIG. 17 is a schematic view of the computing device with a screen displaying a grand prize awarded to the user of the computing device.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

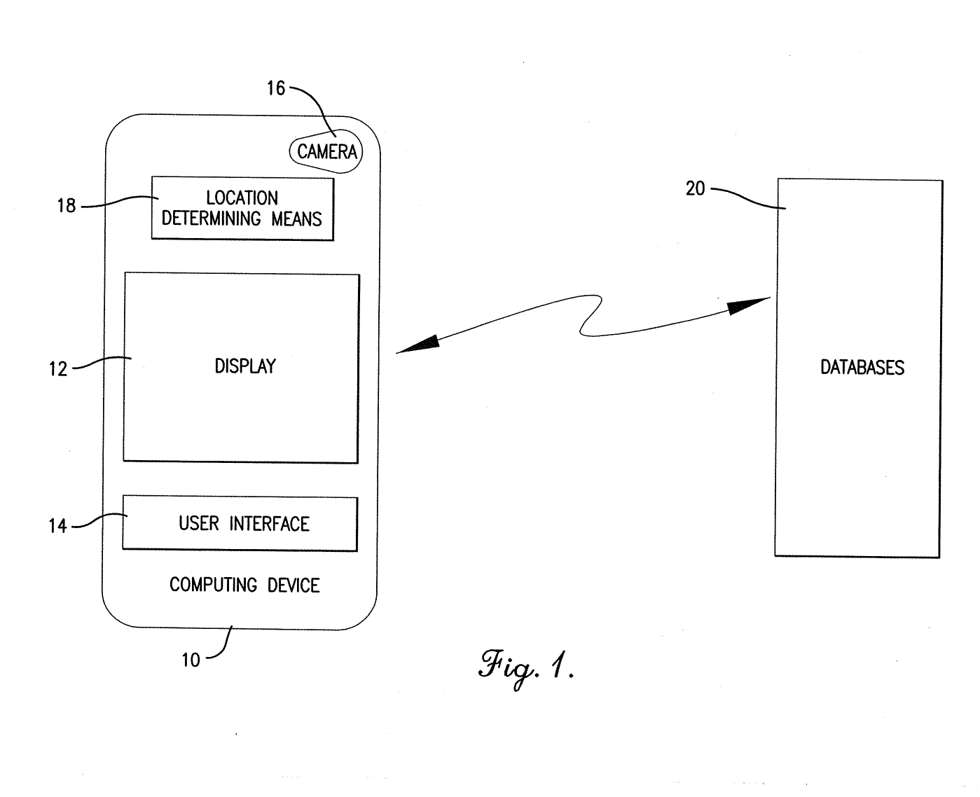

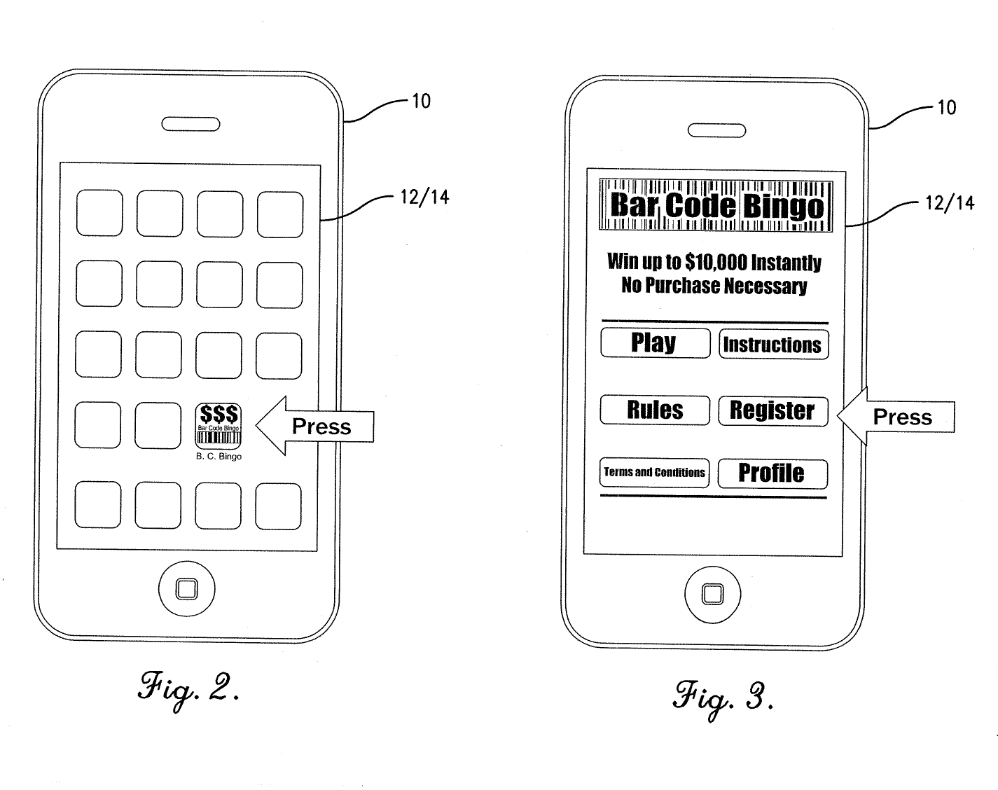

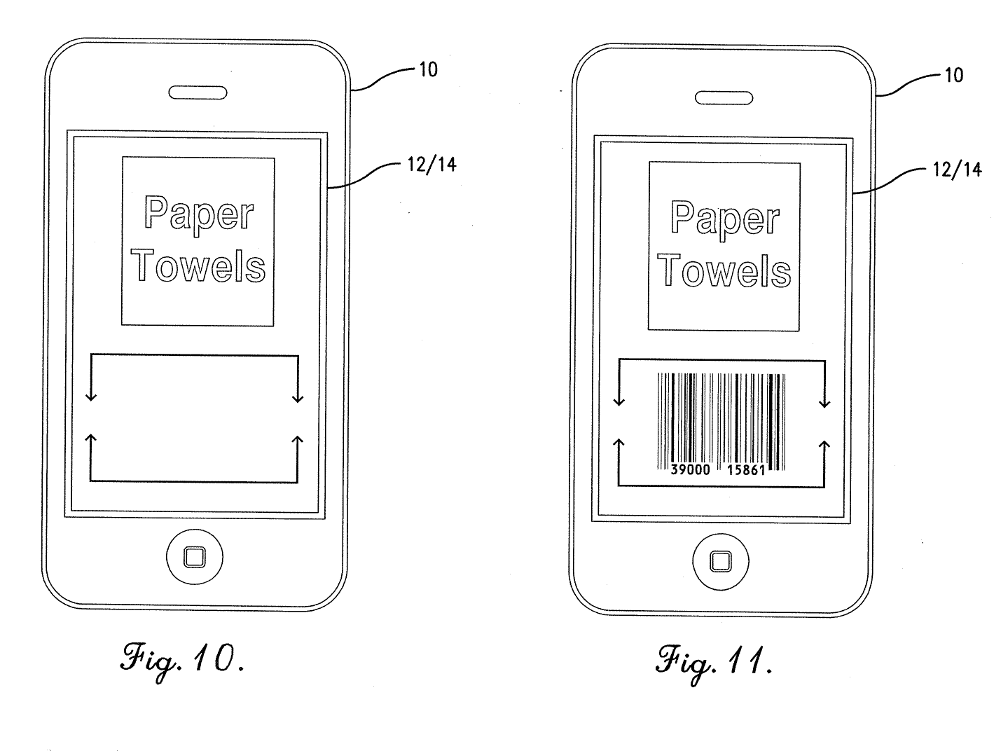

The present invention, as illustrated in FIGS. 2-17, is a matching game and/or computer program configured for enabling a user or player to play the matching game and receive rewards via a computing device 10, as illustrated in FIG. 1. The user or player, as defined herein, may be any individual using the computing device 10 to play the matching game. The matching game may have similar or identical rules to bingo or keno. The matching game may be implemented as a smartphone app, computer software program, or any other computer-executable code which may be stored on a computer-readable medium. A smartphone app, as referenced herein, may refer to any application or program, especially a small one designed for an electronic mobile device. Note that the phrases “bar code”, “scannable code”, or “code” used herein may refer to any type of scannable identification, such as barcodes, QR codes, RFID tags, or NFC tags, as later described herein.

Computing Device

The computer program (e.g., smartphone app, computer software program, or computer-executable code) of the matching game may be uploaded, programmed onto, or otherwise accessed by the computing device 10, as illustrated in FIG. 1. The computing device 10 may be any computing device such as a computer, mobile phone, smartphone, laptop, tablet, or any other similarly equipped device. The computing device 10 may comprise any number or combination of controllers, circuits, integrated circuits, programmable logic devices such as programmable logic controllers (PLC) or motion programmable logic controllers (MPLC), computers, processors, microcontrollers, transmitters, receivers, other electrical and computing devices, and/or residential or external memory for storing data and other information accessed and/or generated by the matching game computer program. As illustrated in FIG. 1, the computing device 10 may also comprise and/or be communicably coupled to a display 12 (e.g., a touch screen display), a user interface 14, a camera 16, a bar code scanner, a charge-coupled device (CCD) sensor, location-determining means 18 such as a GPS receiver, cell tower triangulation means, and/or other components commonly found in personal computers, mobile phones, smartphones, tablets, etc.

The computing device 10 may be configured to implement any combination of the algorithms, subroutines, or code corresponding to method steps and functions described herein. The computing device 10 and computer programs described herein are merely examples of computer equipment and programs that may be used to implement the present invention and may be replaced with or supplemented with other controllers and computer programs without departing from the scope of the present invention. While certain features are described as residing in the computing device, the invention is not so limited, and those features may be implemented elsewhere. For example, databases accessed by the computing device for retrieving advertiser and game-related information may be located remotely from the computing device 10 without departing from the scope of the invention.

The computing device 10 may implement the computer program and/or code segments to perform various steps of the matching game as well as other functions and method steps described herein. The computer program may comprise an ordered listing of executable instructions for implementing logical functions in the computing device 10. The computer program can be embodied in any computer-readable medium for use by or in connection with an instruction execution system, apparatus, or device, and execute the instructions. In the context of this application, a “computer-readable medium” can be any means that can contain, store, communicate, propagate, or transport the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), a portable compact disk read-only memory (CDROM), an optical fiber, multi-media card (MMC), reduced-size multi-media card (RS MMC), secure digital (SD) cards such as microSD or miniSD, and a subscriber identity module (SIM) card.

The residential or external memory may be integral with the computing device 10, stand alone memory, or a combination of both. The memory may include, for example, removable and non removable memory elements such as RAM, ROM, flash, magnetic, optical, USB memory devices, MMC cards, RS MMC cards, SD cards such as microSD or miniSD, SIM cards, and/or other memory elements. Specifically, the memory may store at least a portion of the computer program or code segments described above, as well as user- or player-specified preferences, information regarding player selections and/or scanned barcodes, QR codes, RFID tags, or NFC identification data, and information received from external databases regarding specific images, logos, prizes, and advertisements to present on the display based on time, day, date, month, and/or location of the computing device.

The computing device 10 may also be communicably coupled to one or more remote databases 20 and/or Web sites associated with the matching game and/or the computer program. The databases 20 may comprise a plurality of barcodes, QR codes, RFID, or NFC identification information associated with participating advertisers, as well as GPS coordinates of a plurality of participating retailers. The terms “participating advertisers” and “participating retailers” may refer to companies, brands, or individuals that either purchase advertising space and/or provide prizes to be awarded via the matching game. The databases 20 may also comprise information regarding a plurality of prizes associated with particular codes or particular combinations of codes, as well as other various parameters which may be programmed and reprogrammed via the Web site or an administrator based on a desired probability that a player will win a particular prize. The databases 20 may also store information gathered from the computing devices regarding how often the matching game is played, which stores were visited, which products were scanned, which products were purchased, how many players won, what types of prizes were won, etc. The databases 20 may also contain information regarding which codes are associated with which brands, which codes are associated with instantly winning prizes, which codes are associated with granting the player a marked space, which codes are associated with granting the player bonus spaces, or any other game parameters. Note that the information and game parameters described above may be stored directly to memory on the computing device 10, stored exclusively in the databases 20, and/or stored on a combination of the computing device 10 and the databases 20 without departing from the scope of the invention.

The display 12 may comprise a graphical interface operable to display visual graphics, images, text, etc. in response to external or internal processes and commands. For example, the display 12 may comprise conventional black and white, monochrome, or color display elements including CRT, TFT, LCD, and/or LED display devices. The display 12 may be integrated with the user interface 14, such as in embodiments where the display 12 is a touch screen display to enable the player to interact with it by touching or pointing at display areas to provide information or selections to the computing device 10. The display 12 may be coupled with the computing device 10 and may be operable to display various information corresponding to the matching game, such as instructions, virtual game cards, data from the remote databases such as brand logos, real time images provided by the camera 16 of bar codes or QR codes or the like, location-dependent information, etc.

The user interface 14 may enable one or more users or players to share information with the computing device 10 in order to play the matching game, as later described herein. The user interface 14 may comprise one or more functionable inputs such as buttons, switches, scroll wheels, a touch screen associated with the display (as noted above), voice recognition elements such as a microphone, pointing devices such as mice, touchpads, tracking balls, styluses, cameras such as a digital still or video camera, combinations thereof, etc. Further, the user interface 14 may comprise wired or wireless data transfer elements such as a removable memory, data transceivers, etc., to enable the user or player and other devices or parties to remotely interface with the computing device 10 while playing the matching game. The user interface 14 may also include a speaker for providing audible instructions and feedback.

The camera 16 may be any type of digital camera integral or communicably coupled with the computing device, such as cameras built into smartphones, mobile phones, tablets, and the like. The computer program or other integrated software programs or apps may use image data received from the camera 16 to interpret bar codes, QR codes, or other indicia placed in front of a lens of the camera 16 by the user or player while playing the matching game. In some embodiments of the invention, the computing device 10 may comprise or be communicably coupled to any type of indicia scanner (e.g., bar code or QR code scanner) and/or a charge-coupled device (CCD) sensor, either of which may be used in place of the camera 16 and/or in addition to the camera 16. Furthermore, the computing device 10 may contain a chip to enable contactless transactions via near field communications (NFC) and/or Radio Frequency Identification (RFID) in addition to or in place of the camera, indicia scanner, or CCD sensor.

The location-determining means 18 may include a GPS receiver or any other location-determining means, such that the computing device may use its identified current location to cooperatively determine if the player is in a participating store and to then determine which brands to display in the game based on participating brands and products sold at that particular store. Other conventional receivers, transmitters, mics, speakers, and other components or apps common to a mobile phone or smartphone may also be integrated with and/or utilized by the computing device 10 for playing the matching game without departing from the scope of the invention.

Matching Game

Example screen shots of the matching game computer program, as displayed on the computing device 10, are illustrated in FIGS. 2-17. The matching game computer program may be configured to present a game interface on the display similar to traditional bingo, as known in the art. Alternatively, the matching game computer program may be configured to present a game interface on the display similar to traditional keno. In traditional bingo, each player is provided with a game card having a plurality of squares drawn thereon. In each square is one of a plurality of grid indicia, such as letters, numbers, designs, or words. A player or another individual moderating the game draws or randomly selects one of the grid indicia, and if a player's game card has that particular grid indicia, they mark any squares or spaces in which that grid indicium is located. Once the player has marked an entire row, column, or either diagonal of the grid, the player yells “bingo” and wins that round or game of bingo, typically receiving a prize. In some instances, a player must fill up the entire grid (i.e., all squares marked)—referred to as “black out”—to win a round of bingo.

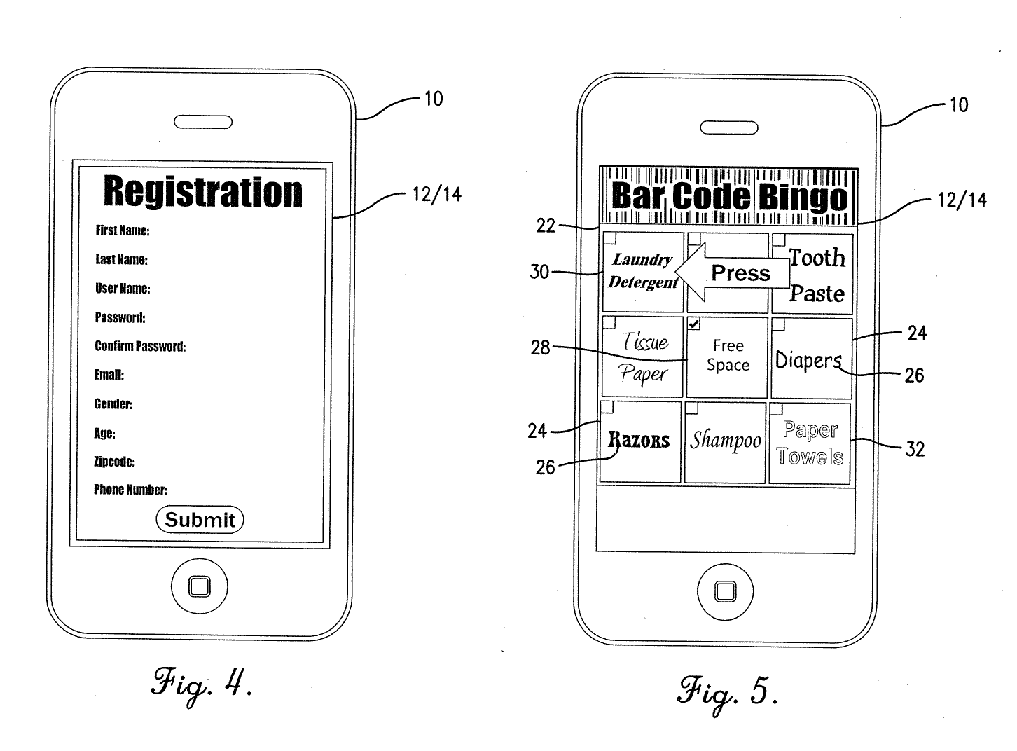

To play the matching game of the present invention, a user or player may first select a selectable “matching game” indicium illustrated on the display 12 of the computing device 10, as illustrated in FIG. 2. Then a home screen may be presented to the player on the display 12, as illustrated in FIG. 3. The home screen may have a plurality of selectable indicia allowing the player to play the game, register to win prizes by playing the game, review rules of the game, etc. If the player selects indicium corresponding to registering for the game, as illustrated in FIG. 3, the display 12 may provide a fillable registration form, as illustrated in FIG. 4. The player may then enter any information required by administrators of the game in order to receive prizes for winning the matching game or winning rounds of the matching game. This registration information may be communicated to the databases 20 described above for use by the administrators of the game and/or by participating advertisers.

Once the player has registered and/or has selected an indicium indicating that they are ready to play the matching game, a virtual game card 22 having a grid configuration similar to a traditional bingo card may be presented to the player on the display 12, as illustrated in FIGS. 5, 9, 13, and 14. Any size grid may be used with any number of squares or spaces 24 of any shape arranged in a grid pattern of rows and columns, as pre-programmed or as selected by the user or player. The squares or spaces 24 on the grid may have one or more indicia 26, such as an image, logo, or text, displayed therein or thereon representing a brand of products. Additionally or alternatively, the indicia 26 of some spaces 24 may include an image of a specific product within that brand or a parent company logo or name which may encompass several brands. The indicia 26 may additionally or alternatively include text, such as the brand name. In some embodiments of the invention, the indicia 26 of at least one of the spaces 24 may indicate (through text and/or graphics) that it is a “free space”, meaning that the player may use that space to form a winning row, column, or diagonal of spaces 24 on the grid or virtual playing card, as illustrated in FIGS. 5, 9, 13, and 14.

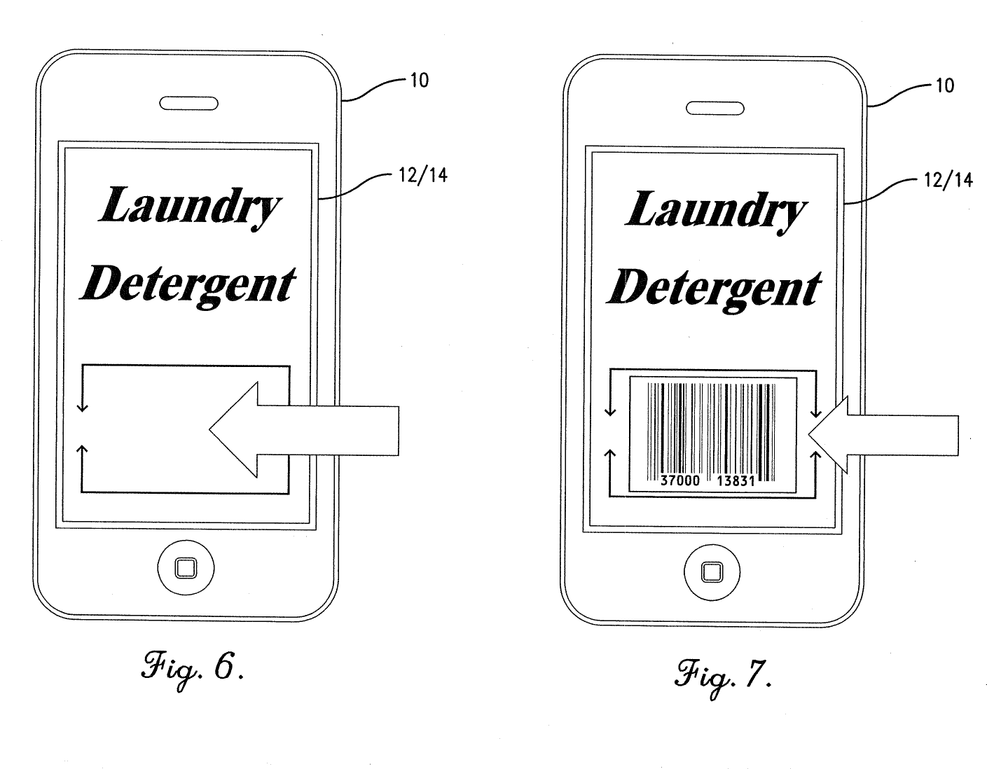

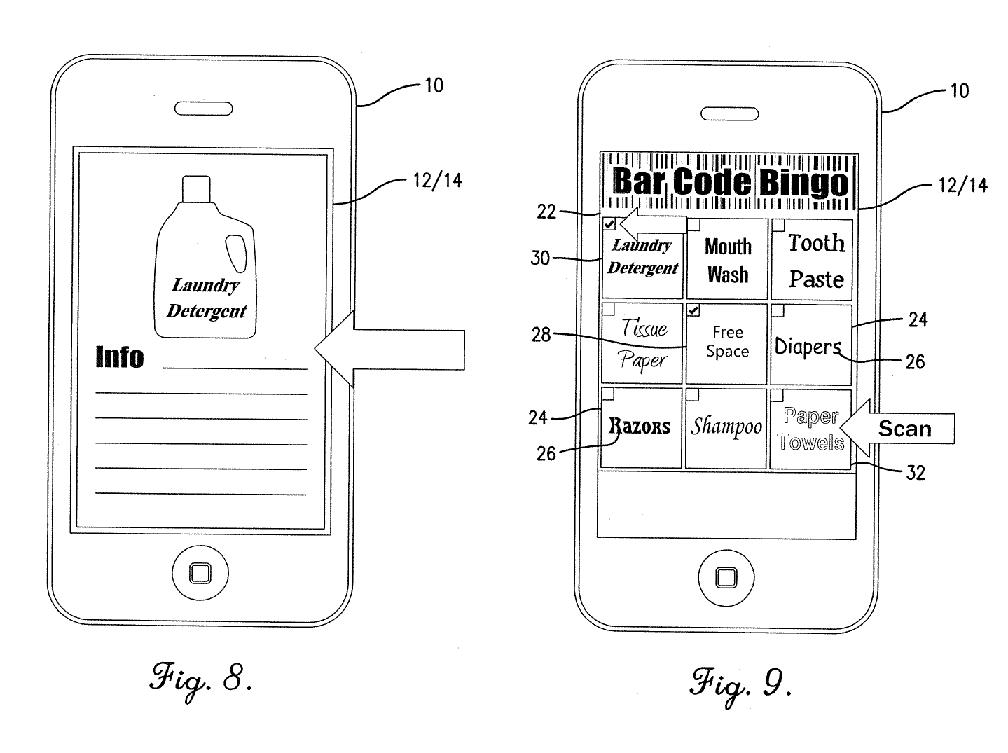

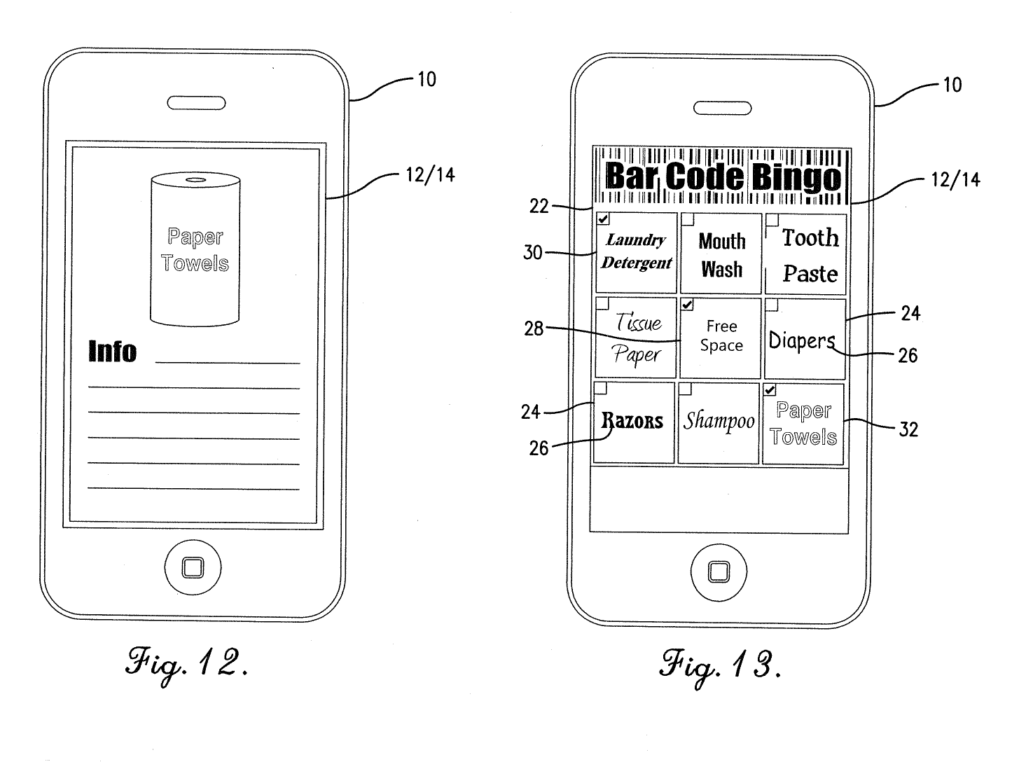

The matching game computer program may instruct the player (via the display 12) to find products in a store that correspond to or match indicia 26 on the spaces 24 of the virtual game card 22. As each product is found, the player may scan the product or a code displayed on the product either using optical scanning, RFID protocols, NFC protocols, or any other applicable method of identifying the product to the computing device, as illustrated in FIGS. 6, 7, 10, and 11. Once the computing device 10 has scanned the product or its corresponding code, the matching game computer program may be configured to display an ad (still image or video clip), a product image, and/or additional information about the item corresponding to the product or code, as illustrated in FIGS. 8 and 12. This ad may be displayed for a predetermined length of time or may be skipped by the player by selecting a menu option on the display 12 or screen.

The matching game computer program may then be configured to “mark” one of the spaces 24 when a scannable code corresponding with the company, brand, or product indicated by the indicium of that space is scanned, as illustrated in FIGS. 9, 13, and 14. This mark on one of the indicia 26 or spaces 24 may be visible on the display 12 and also indicated in memory on the computing device 10. In some embodiments of the invention, scanning or photographing a bar code, QR code, RFID tag, or NFC tag of any product of an indicated brand may be sufficient to mark the associated one of the spaces 24. In other embodiments of the invention, the space may not be marked unless a specific one of a plurality of scannable codes associated with that particular company or brand is scanned. Therefore, while the player may know that they need to scan a code of a product of a particular brand in order to mark a particular space, the exact product within that brand that needs to be scanned may not be identified to the player. This creates an element of luck or probability within some embodiments of the matching game.

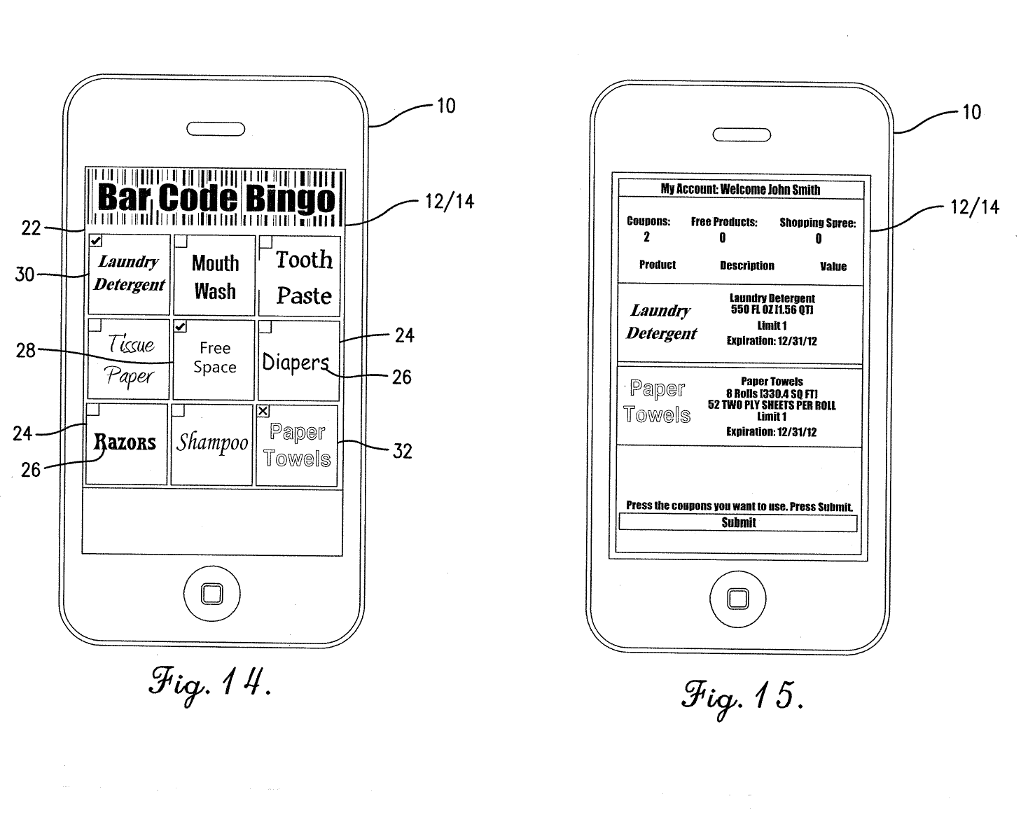

Furthermore, if the player scans a scannable code of a product matching one of the brands on the virtual game card 22, but it is not the pre-selected product required to mark the associated space, the space or indicia thereof may be negatively marked in some way indicating that that space is no longer available to create a winning row, column, diagonal, or blackout, as illustrated in FIG. 14. For example, if the correct code for a specific brand is scanned, the corresponding space or spaces may be positively marked with a first color or symbol (e.g., a green check mark) indicating that the space may be used to form a winning row, column, diagonal, or blackout. Examples of positively marked spaces are illustrated in FIGS. 9, 13, and 14, in which a free space 28 is positively marked and a first selectable space 30 (e.g., the laundry detergent space) is positively marked. Furthermore, FIG. 13 illustrates a second selectable space 32 (e.g., the paper towels) being positively marked and forming a winning diagonal combination of the spaces 24 with the first selectable space 30 and the free space 28. However, if an incorrect code for that same brand is scanned, the space or spaces 24 having indicia 26 corresponding to that brand may be negatively marked with a second color or symbol (e.g., a red X) indicating that those spaces can no longer be played and may not be used to form a winning row, column, diagonal, or blackout. For example, FIG. 14 illustrates the second selectable space 32 (e.g., the paper towels) being negatively marked with an X, meaning that the diagonal formed by the first selectable space 30, the free space 28, and the second selectable space 32 does not form a winning combination of spaces.

If the grid or virtual game card 22 is marked with the second color or symbol in such a way that it is no longer possible to form any of a winning row, column, diagonal, or blackout with the current displayed virtual game card 22, the matching game computer program may be configured to indicate this to the player via the display 12 (e.g., provide words “game over” on display) and/or may provide the player with a new virtual game card to begin a new game having a different combination of indicia thereon. Otherwise, the player may continue to try to form other winning combinations of spaces by continuing to scan codes of products corresponding with the indicia 26 on the virtual game card 22.

Note that, in some embodiments of the invention, the computing device 10 may be used to scan bar codes or QR codes displayed on product packaging or printed on the product or a product sale tag. However, the bar code or QR code may additionally or alternatively be presented in various other ways. For example, the bar code or QR code scanned or photographed to mark the spaces 24 on the virtual game card 22 may be bar codes or OR codes displayed on a graphical interface, display, television screen, computer screen, or the like, or may be a bar code or QR code on a poster, sign or display in a particular store.

In some embodiments of the invention, the matching game computer program may be played by pressing or selecting one or more of the brand images pictured on the display (as depicted in FIGS. 5 and 9) and then scanning and/or photographing the bar code on the product. If the product scanned matches one or more of the codes in the database of codes for the brand being scanned, a successful match is indicated on the display (as in FIG. 9). For example virtual game cards in which there are 9 spaces total, with a center space being a “free space,” if two or more scanned images in opposing corners match the predetermined winning codes, the player has made a “bingo” (as in FIG. 13) and may either win a prize instantly or be entered into a random drawing for a larger daily, weekly or monthly prize, e.g., $1000, $5000, $10,000, $25,000, up to $1,000,000, depending on the number of players and the sponsored advertising.

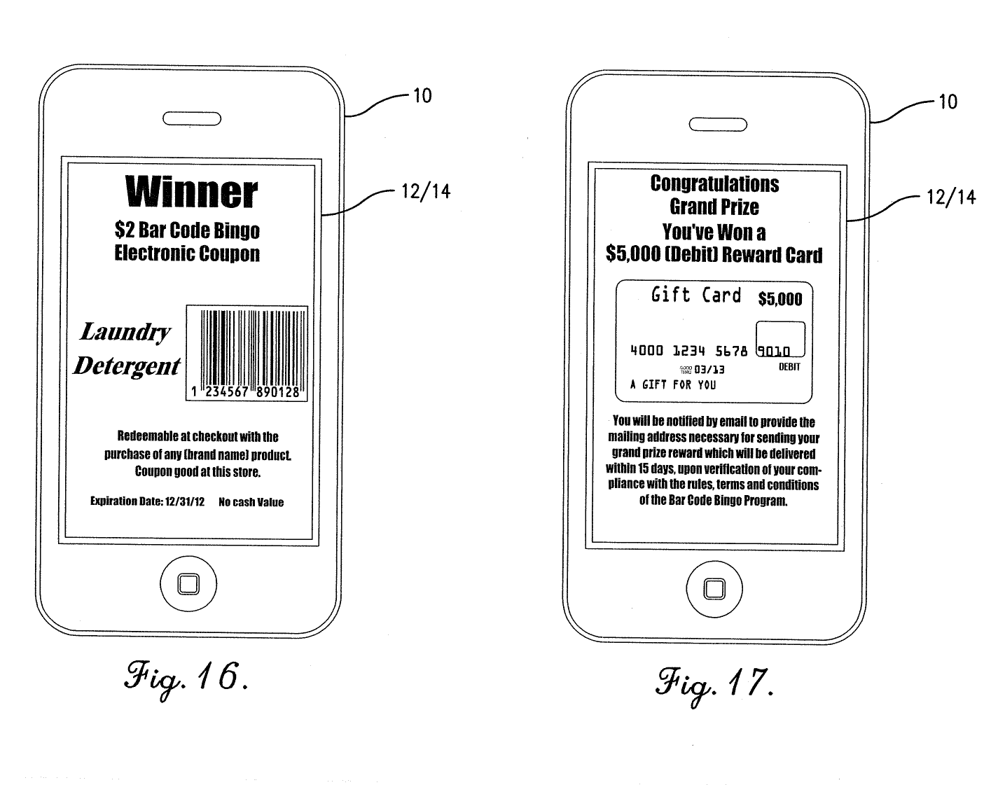

Various prize screens are illustrated in FIGS. 15, 16, and 17. FIG. 15 illustrates a list of prizes won by the player, which may be stored in the databases 20 and/or the computing device 10 and accessible by the player at a later date up until an expiration date, if so desired. FIG. 16 illustrates a coupon which may be won by the player. For example, a coupon may be won if the player forms a “bingo” by matching products of each space of an entire row, an entire column, or a diagonal displayed on the virtual game card 22. FIG. 17 illustrates an example grand prize screen which may appear if the player obtains a black out (all spaces 24 positively marked) or is selected at random for the larger daily, weekly, or monthly prizes noted above.

In some embodiments of the invention, players are only allowed to scan one product associated with a selected one of the spaces 24 during each attempt to match a code (e.g., a bar code) associated with that space, as described above. Providing a new virtual game card with different matching codes corresponding to the different indicia 26 may prevent continuous attempts to match a scannable code with a winning code in the database unless the game is programmed to allow more than one attempt to match codes of scanned products with winning codes of any one virtual game card. Several indicia can be loaded and programmed to randomly be displayed on the virtual game card 22 and the number of times a particular indicium is displayed during a period of time or per virtual game card can be determined by the sponsored advertising purchased.

The matching game computer program may be configured to only allow game play while a player or the computing device is at a location where the product being scanned is available. Location may be confirmed by one of the location determining means 18 disclosed above. Additionally or alternatively, the matching game computer program may be programmed to allow home scanning for purposes of creating a shopping list. In some embodiments of the invention, this home scanning may be done via a website, home scanner, and home computer and later transmitted or uploaded to the computing device described above, such as a smartphone or tablet. However, players may not be allowed to win prizes by scanning products in their homes, which could defeat the goal of the matching game of stimulating additional trial and sales for the brands being picked up and scanned in the stores. If products are scanned at home through the use of a home scanner instead of a camera or scanner on a mobile computing device, shopping lists can either be printed or transferred to the computing device through a website or other transfer means for use in shopping. In some embodiments of the invention, any products or categories on the shopping list could be used to populate the virtual game card 22 to increase consumer incentive to purchase a brand featured on the virtual game card 22.

In some embodiments of the invention, products or categories that are competitive to those on the shopping list may be used to populate the virtual game card 22 to encourage shoppers to switch brands or categories by offering an increased savings (e.g., discount coupon). This may provide competitors with a valuable marketing advantage before a purchasing decision is made, rather than giving an incentive on a cash register receipt or loyalty reward program only after the purchase, when it is too late to create an instant incentive for shoppers to change their buying preference.

The matching game described herein is configured to encourage a maximum number of consumers to visit stores that stock products whose images or logos are displayed on the virtual game card 22 provided on the display 12. The matching game is also configured to encourage consumers to pick up the products in those stores and scan the products' scannable codes in hopes of matching the scannable codes on the products with one or more preselected winning codes in the associated database in order to be awarded a space (e.g., positively marking the space) on the virtual game card 22. Note that for any given brand there may be tens, hundreds, or thousands of products, each with their own distinct scannable code. Therefore, scanning a code associated with a brand shown on the virtual game card 22 may not guarantee that the player be awarded the space on the virtual game card 22.

However, in some embodiments of the invention, the database may be set to increase the probability of a space being marked by allowing several scannable codes to result in a winning space or a positively marked space. For example, if a particular brand is associated with 100 bar codes in a particular store where the computing device is currently located, the matching game computer program or database may be programmed to grant a winning space or positively mark the space if any of 10 preselected winning bar codes are scanned by the player. Furthermore, associated brands (e.g., those owned by the same company) could be grouped such that scanning a matching product for one brand may also cause another space of an associated brand to be positively marked on the virtual game card 22, thereby giving the player a “bonus space.” Furthermore, the matching game computer program and database may be programmed to provide instant prizes for a select few scannable codes or may positively mark bonus spaces on the virtual game card 22 for a select few scannable codes.

In some embodiments of the invention, a comparison shopping feature may be provided on the virtual game card or on another screen of the matching game, allowing the player or user to view prices of the same products available at other stores or to view prices of that product found online through various Web sites. However, some individual retailers may prefer that shoppers do not have the ability to compare prices with other stores and online sites, which could lead to the shopper going elsewhere to make a purchase. Therefore, in some embodiments of the invention, advertisers and/or retailers carrying the products featured on the virtual game card 22 may be provided the ability to control whether or not a comparison shopping feature can be activated by the shopper or the player. Specifically, control of the comparison shopping feature may be based on a game administrator's decision and/or a sensed location where the player is shopping. For retailers desiring to build customer loyalty by offering price matching or retailers that typically have the lowest prices in a particular area, they may choose to have the comparison shopping feature turned on when players play the matching game at their retail locations.

The various methods of awarding or positively marking the spaces 24 to the players may be determined based on how frequently, on average, the sponsor or advertiser wants one of the players to win. The matching game computer program may also be configured to randomly create virtual game cards with random combinations of brands, images, logos, text, or free spaces. In some embodiments of the invention, the number of squares or spaces 24 provided on the virtual game card 22 may be selected by the player, and larger prizes may be awarded for a virtual game card with a greater number of squares or spaces 24, since the chances of winning decrease.

The matching game computer program may allow for registration either before or after playing in order to receive a prize. Registration can be entered on computing devices or through a web site. It may be less hassle for the player to register after the player has won something and more motivation to register. Once registered, the player will be able to either store their prize on their computing device (e.g., a phone or computer) for later redemption by mail or email or, if merchant allows, redeem a coupon or prize at checkout by scanning the bar code or entering a redemption code provided to the player's computing device. Then the amount may be deducted from the player's purchase in the same manner as a cent-off, dollar-off, or percent-off coupon or free product coupon and, at the same time, the prize may be deducted from a personalized account balance associated with the player, so that the prize may only be redeemed once. Additionally or alternatively, when a winning combination of scannable codes is scanned for a given virtual game card, a link to a web page may be provided or may automatically open, with the web page configured to display a coupon, a bar code or QR code for an online or in-store prize, and/or a code which may be entered and redeemed online for the given prize. However, any method of providing a prize to the player may be utilized without departing from the scope of the invention.

Therefore, the matching game computer program may offer the advantage of instant gratification rather than having to wait a week or longer to receive a prize. The prizes may be paid to the player's personalized account as soon as the system verifies the player has successfully matched the required number of spaces 24 and has played according to the official rules (e.g., minimum age, geographic location where game is available, player has not attempted to hack the game, void where taxed or prohibited, etc.). The official rules of the matching game may be published with the game for review by the player when they register and/or by way of a link within the game which provides the official rules on the display when the link is selected by the player.

The matching game computer program may be configured to display all of the indicia 26 (e.g., 8 squares containing logos, brand names, or text) necessary to make a regular bingo or black out bingo on a single screen, which eliminates the need and time required by other in-store games to go to several screens to see all the brands and categories available for scanning. The matching game computer program provides a self contained, brand building game that only displays images, text, or logos of products. The matching game does not require collecting any points, tokens, or coins in order to play other games of chance that are not associated with the product images or logos. However, in some alternative embodiments of the invention, the prizes awarded via the matching game may be some sort of digital credits which may be used in other games accessible with the computing device or other game consoles.

The matching game computer program may also be configured to provide various ways for players to win instantly. For example, in some embodiments of the invention, if the player has a perfect match of all images or logos on the virtual game card 22 with specific scannable codes of that brand pre-selected from an associated database, the player may win a large prize instantly, such as a $5,000 gift card or credit that could be mailed, emailed, or delivered directly onto the player's computing device (or the player could be provided with a Web link or a code to redeem the prize, as described above). Additionally or alternatively, even if the specific pre-selected codes are not scanned, some smaller prize may be awarded if the player scans any codes associated each of the indicia 26, images, or logos on the displayed virtual game card 22. For example, the prize for scanning codes associated with each of the brand logos on the virtual game card 22 may be automatic entry of the player for a random drawing each day, week, or month for a range of prizes (e.g., from $5 or $10 to $500).

There may be various quantities and types of prizes and the odds of winning a prize may be based on the number of players playing any given day, week, or month, as well as the time, date, and/or location of the computing device. For example, there could be 100 or 100,000 daily, weekly, or monthly prizes. Lesser prizes could be offered if a player scanned only two or three codes associated with the indicia 26, images, or logos on the displayed virtual game card. In some embodiments of the invention, consumers who play the matching game may also be encouraged to post their winning virtual game cards or screens in a video on a publicly viewable website, such as YouTube™, for the chance to win an additional daily, weekly or monthly prize for the best video which could be picked based on the highest number of views for a particular video or any other chosen criteria. This may give participating manufacturers additional exposure for their brands and or logos that are displayed on the virtual game cards and may also encourage more people to play the matching game.

The matching game computer program is designed to encourage shoppers to look for and scan products corresponding to the indicia 26 on the display 12 and be motivated to purchase products they have scanned. Sales of scanned products may be recorded in the databases 20 for comparison with store sales of the same products before, during, and after brands participate by having their indicia (e.g.; text, images, or logos) appear on the virtual game cards of the matching game.

The matching game computer program may use a website for registration and collection of advertisers' information and for entering images or logos for the matching game. The Web site can also be used for billing to and payment from participating manufacturers' brands. This type of automated advertising and billing process can make it possible to sell spaces 24 on the virtual game cards similar to the bidding manner in which the search engine Google™ sells sponsored ads. Other interactive Internet consumer product promotion methods and games are not programmable to allow changes in the images and/or logos on a pre-defined, limited content (e.g. 8 logos) game screen based on sponsors bidding for a local, national, or international spot on one or more virtual game cards. In some embodiments of the invention, advertising space on the matching game's virtual game cards may be offered on a cost per mille (CPM), cost per thousand exposures, cost per click (CPC), or cost per point (CPP) basis, among other online advertising revenue models. However, any method of soliciting advertisements and charging advertisers may be used without departing from the scope of the invention.

Advantageously, the matching game computer program may provide a unique opportunity for advertisers to increase awareness for their products displayed on an uncluttered game screen (e.g., maximum 8 or 9 indicia) and quickly test consumers' responses to different prices, sizes, formulations, and packaging. Each scan of each product may be recorded in the database for access by advertisers having images or logos on virtual game cards of the matching game. As stated earlier, advertisers may be charged in a variety of ways, such as: cost per thousand image or logo impressions (CPM), cost per click on sponsored image or logo (CPC), or cost per action (CPA) when a consumer actually buys a product whose image or logo was displayed in the matching game. In some embodiments of the invention, the matching game may also provide an in-game ad content platform and advertising distribution channel for Google™, Microsoft®, Motorola® or various media partners and content providers. In some embodiments of the invention, when the consumer selects (e.g., touches or clicks on) an image or logo to play the matching game, a short (e.g., 5 seconds) audio or video message may also be triggered while a code match (barcode, QR code, etc.) is being verified.

The current invention addresses and helps solve three problems: (1) Create more store traffic, sales and profits for retailers who invite consumers to play the matching game. Stores may be encouraged to participate by advertising the matching game on their shelves, shopping carts, in-store public address announcements, newspapers, free-standing newspaper supplements, direct mail, email, social media sites such as FACEBOOK, TWITTER, or YouTube™, and/or on the store's websites. This would give participating manufacturers additional exposure for their brands and or logos that are displayed on the screen. This would also encourage more people to play the matching game. (2) Create more consumer interest in looking for the products in stores whose images or logos are pictured in the matching game on their smartphones. Consumers may scan, match, and win prizes by playing the matching game. It's fast and free. Consumers can win discount coupons, free products, shopping sprees, or prepaid gift or reward cards. (3) Create more sales and profits for manufacturers who advertise their brand images and/or logos in the matching game. Retailers may be encouraged by manufacturers to buy and advertise products featured in the matching game.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of facilitating a matching game, the method comprising:
displaying a virtual game card on a display of a computing device, the virtual game card comprising a plurality of indicia displayed in a grid format;
receiving information scanned by the computing device;
positively marking at least one of the plurality of indicia by changing at least one visual element of the at least one of the indicia in a first manner if the at least one of the indicia corresponds to the information scanned by the computing device;
negatively marking at least one of the plurality of indicia by changing a visual element of the at least one of the indicia in a second manner if the at least one of the indicia does not correspond to the information scanned by the computing device;
continuing to receive information scanned by the computing device and to positively or negatively mark at least one of the indicia until each of the plurality of indicia on the virtual game card is positively or negatively marked or until at least one winning combination of indicia is positively marked; and
displaying an indication that at least one winning combination of indicia is positively marked on the virtual game card, thereby indicating that a user of the computing device won the matching game.

2. The method of claim 1, wherein the matching game is bingo or keno, the virtual game card is a bingo game card or a keno game card, and the winning combination is determined based on the rules of bingo or keno.

3. The method of claim 1, wherein the information scanned by the computing device is at least one of a barcode, a QR code, a Radio Frequency Identification (RFID) tag, and near field communications (NFC) identification information.

4. The method of claim 3, wherein the information scanned by the computing device is scanned by at least one of a camera, a barcode scanner, a RFID scanner, or a NFC scanner physically and/or communicably coupled with the computing device.

5. The method of claim 1, further comprising a step of displaying an indication of whether or not a current geographical location of the computing device is at a geographic location participating in the matching game.

6. The method of claim 5, further comprising a step of preventing the positive or negative marking of the indicia if the current geographical location of the computing device is not at a geographic location participating in the matching game.

7. The method of claim 1, wherein the plurality of indicia on the virtual game card are each associated with a brand of products, wherein neither a negative nor a positive marking can be made on the virtual game card if the information scanned by the device is not associated with one of the brands of products associated with one of the plurality of indicia on the virtual game card.

8. The method of claim 1, wherein the information scanned by the computing device includes a code of a specific product belonging to a specific product brand, wherein the plurality of indicia on the virtual game card are each associated with at least one desired code and at least one specific desired product brand.

9. The method of claim 8, further comprising positively marking the at least one of the plurality of indicia on the virtual game card if the code and the specific product brand of the specific product match the at least one desired code and the at least one specific desired product brand associated with the one of the plurality of indicia.

10. The method of claim 8, further comprising negatively marking the at least one of the plurality of indicia on the virtual game card if the specific product brand of the specific product matches the at least one specific desired product brand, but the code of the specific product does not match the at least one desired code associated with the one of the plurality of indicia.

11. The method of claim 1, further comprising crediting a particular award to an account associated with the user of the computing device when at least one winning combination of indicia is positively marked on the virtual game card.

12. The method of claim 11, wherein the award is a code scannable and/or redeemable for free or discounted goods or services from at least one particular store, at least one particular retailer, or at least one particular website.

13. A non-transitory computer-readable medium with a computer program stored thereon and configured for facilitating playing a matching game via a computing device, the computer program comprising:
a code segment executable by the computing device for displaying a virtual game card on a display of the computing device, the virtual game card comprising a plurality of indicia displayed in a grid format;
a code segment executable by the computing device for receiving information regarding at least one code scanned by the computing device;
a code segment executable by the computing device for positively marking at least one of the plurality of indicia by changing at least one visual element of the at least one of the indicia in a first manner if the at least one of the indicia corresponds with the at least one code scanned by the computing device; and
a code segment executable by the computing device for displaying an indication that at least one winning combination of a plurality of the indicia is positively marked on the virtual game card and displaying an award image or code and/or crediting an award to an account associated with a user of the computing device for winning the matching game.

14. The computer-readable medium of claim 13, further comprising:
a code segment executable by the computing device for negatively marking at least one of the plurality of indicia by changing a visual element of the at least one of the indicia in a second manner if the at least one of the indicia does not correspond with the at least one code scanned by the computing device; and
a code segment executable by the computing device for indicating that a user has lost the matching game if a particular combination of negatively marked indicia on the virtual game card makes it impossible to form a winning combination of positively marked indicia on the virtual game card.

15. The computer-readable medium of claim 13, wherein the matching game is bingo or keno, the virtual game card is a bingo game card or a keno game card, and the winning combination is determined based on the rules of bingo or keno.

16. The computer-readable medium of claim 13, wherein the information scanned by the computing device is at least one of a barcode, a QR code, a Radio Frequency Identification (RFID) tag, and near field communications (NFC) identification information.

17. The computer-readable medium of claim 13, the computer program further comprising a code segment executable by the computing device for displaying an indication of whether or not a current geographical location of the computing device is at a geographic location participating in the matching game and preventing the positive marking of the indicia if the current geographical location of the computing device is not at a geographic location participating in the matching game.

18. The computer-readable medium of claim 13, wherein the code scanned by the computing device is associated with a specific product belonging to a specific product brand, wherein the plurality of indicia on the virtual game card are each associated with at least one desired code and at least one specific desired product brand.

19. The computer-readable medium of claim 18, the computer program further comprising:
a code segment executable on the computing device for positively marking the at least one of the plurality of indicia on the virtual game card if the code and the specific product brand of the specific product match the at least one desired code and the at least one specific desired product brand associated with the one of the plurality of indicia; and
a code segment executable on the computing device for negatively marking the at least one of the plurality of indicia on the virtual game card if the specific product brand of the specific product matches the at least one specific desired product brand, but the code of the specific product does not match the at least one desired code associated with the one of the plurality of indicia.

20. A non-transitory computer-readable medium with a computer program stored thereon and configured for facilitating playing bingo via a computing device, the computer program comprising:
a code segment executable by the computing device for displaying a virtual game card on a display of the computing device, the virtual game card comprising a plurality of game spaces displayed in a grid format forming rows, columns, and two diagonals, each of the game spaces displaying different ones of a plurality of indicia associated with at least one product in a store;
a code segment for receiving a selection from a player of at least one of the game spaces, such that the at least one of the plurality of game spaces becomes a selected one of the game spaces;
a code segment executable by the computing device for receiving information regarding a code scanned by the computing device, wherein the code is displayed on at least one product in the store;
a code segment executable by the computing device for positively marking the selected one of the game spaces by changing at least one visual element of the selected one of the game spaces in a first manner if the selected one of the game spaces corresponds with the code scanned by the computing device;
a code segment executable by the computing device for negatively marking the selected one of the game spaces by changing a visual element of the selected one of the game spaces in a second manner if the selected one of the game spaces does not correspond with the code scanned by the computing device;
a code segment executable by the computing device for continuing to receive selections from the player of at least one of the plurality of game spaces, continuing to receive information regarding codes scanned by the computing device, and continuing to positively or negatively mark the selected ones of the game spaces until at least one winning combination of game spaces is positively marked or a winning combination is no longer possible due to a current combination of game spaces negatively marked; and
a code segment executable by the computing device for displaying an award image or code and/or crediting an award to an account associated with a user of the computing device for winning the matching game if at least one winning combination of game spaces is positively marked,
wherein the winning combination is at least one of an entire row positively marked, an entire column positively marked, either diagonal positively marked, and every one of the plurality of game spaces positively marked.
